(19) United States
(12) Patent Application Publication
(10) Pub. No.: US 2017/0101798 A1
(43) Pub. Date: Apr. 13, 2017

(54) DEVICE FOR SECURING TEMPORARY STRUCTURES

(71) Applicant: Robert H. Koerner, Coal City, IL (US)

(72) Inventor: Robert H. Koerner, Coal City, IL (US)

(21) Appl. No.: 14/877,010

(22) Filed: Oct. 7, 2015

(51) Int. Cl. E04H 12/22; E04H 15/32; B65D 21/02; G09F 15/00; F16M 11/22; B65D 43/02

(52) U.S. Cl. CPC E04H 12/2246; F16M 11/22; B65D 43/02; B65D 21/0219; G09F 15/00; E04H 15/32; F16M 2200/08; G09F 2007/1856

(57) ABSTRACT

A device and method for securing a structural object, including a container having an open top portion and a closed bottom portion; and a slot integrated into the container through an entire height of the container and to about a central portion of the top and bottom portions, and having a width greater than a width of a pole shaped structural object adapted to be received within the slot.

### BACKGROUND OF THE INVENTION

Field of the Invention

The present invention generally relates to devices for securing structures, and more particularly to a device for securing temporary structures, such as open tents, shade structures, signs, and the like.

Discussion of the Background

In recent years, temporary structures have been developed, such as open tents, shade structures, signs, and the like. However, such structures can be light and difficult to maintain in place, due to winds, movement, and the like. Therefore, there is a need a device for securing temporary structures, such as open tents, shade structures, signs, and the like.

### SUMMARY OF THE INVENTION

The above and other problems are addressed by exemplary embodiments of the present invention, which advantageously provide a device adapted to fit around legs of temporary structures, such as open tents, shade structures, signs, and the like, to secure such structures in place.

Accordingly, aspects of the present invention relate to a device and method for securing a structural object, including a container having an open top portion and a closed bottom portion; and a slot integrated into the container through an entire height of the container and to about a central portion of the top and bottom portions, and having a width greater than a width of a pole shaped structural object adapted to be received within the slot.

The container can be cylindrical or rectangular shaped.

The slot can be rectangular, circular or wedge shaped.

The device and method can include a lid having a slot corresponding to the slot of the container so as to fit over and cover the top portion of the container and rotate therearound.

The lid can include an indentation adapted to allow stacking of the closed bottom portion of the container on top of the lid.

The structural object can include a leg of a shade structure, tent or sign.

Still other aspects, features, and advantages of the present invention are readily apparent from the following detailed description, simply by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates a device adapted to fit around legs of temporary structures to secure such structures in place;

FIG. 2 illustrates an integral lid used of the device of FIG. 1;

FIG. 3 illustrates a location of a structural element secured by the device of FIG. 1;

FIG. 4 illustrates the device and lid of FIGS. 1-2 configured around a structural element for securing the structural element;

FIG. 5 illustrates a stackability of a device of FIG. 1 over a lid of FIG. 2 of another device of FIG. 1; and

FIG. 6 illustrates a further embodiment of the device described with respect to FIGS. 1-5.

### DETAILED DESCRIPTION OF THE INVENTION

The present invention includes recognition that numerous structures have been manufactured so as to provide a fast and convenient method of erecting a collapsible framework having extendable legs to support the spreading structural pieces. Such devices are commonly known as shade tent, shade structures, and the like. Such devices may have sides with screens and/or solid wind covers, and typically include an attachable fabric covering on the upper frame to provide sunshade or rain cover, and the like. Such devices are designed to be temporary structures, which are easily collapsed and can transported and stored until their next use. However, such structure have an inherent problem in that they can react to various elements of nature, including movement from wind, other objects, and the like.

For example, due to the nature of an object of the size and portability of such a shade tent, structure, and the like, such structures require some means of support, as they can easily displaced and moved by wind, and the like. In not very extreme circumstances, such structures can be easily lifted and tossed about, creating hazards to life, property, and the like. To counteract such possibilities, the manufacturers of such structures recommend against erecting such structures during inclement weather, existing or predicted. In any case, they may advise securing such structures with stakes, and the like, which can be very time consuming and fail to provide sufficient anchoring support, and the like.

In view of the above and other discovered problems, the present invention provides a means for adding a mass weight to the legs of such temporary structures so as to enable such structures to resist mechanical forces induced by the wind, and the like, and that is simple to employ, and can be easily manufactured using techniques to manufacture commonly produced objects, such as plastic injection molded, buckets, barrels, and the like.

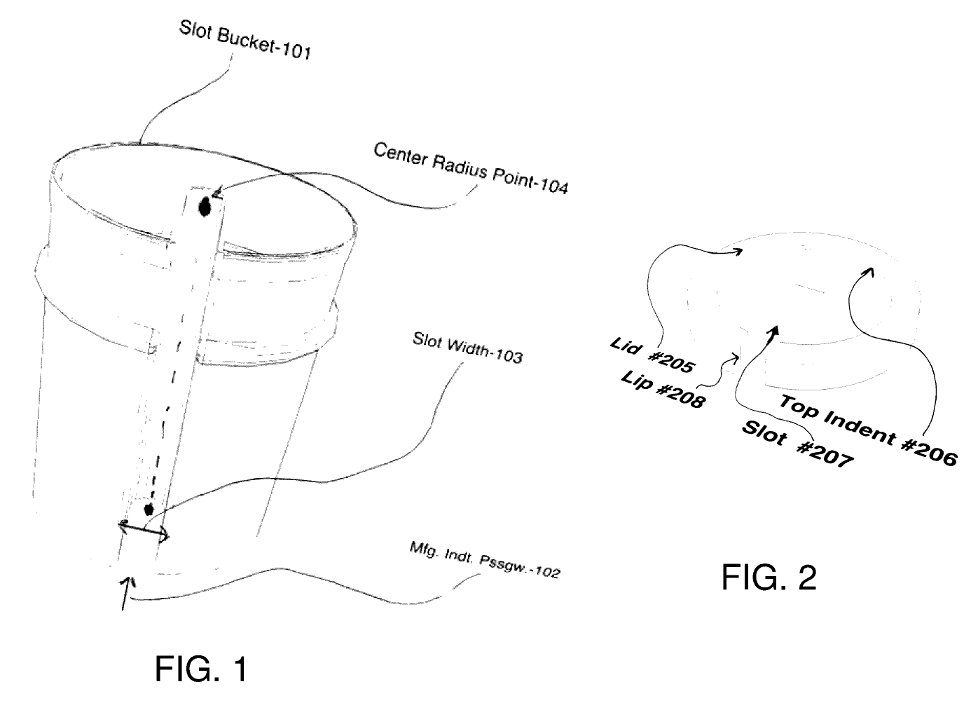

FIG. 1 illustrates a device adapted to fit around legs of temporary structures to secure such structures in place. In FIG. 1, the device 101 provides a simple and succinctly novel method of adding mass to legs of a structure. The device 101 can be configured in the shape of a slotted bucket, barrel, and the like, so that it can be easily manufactured (e.g., made of plastic using plastic injection molding or 3D printing techniques), and can be easily transported and stored (e.g., based on stackable, and nesting type design), and the like.

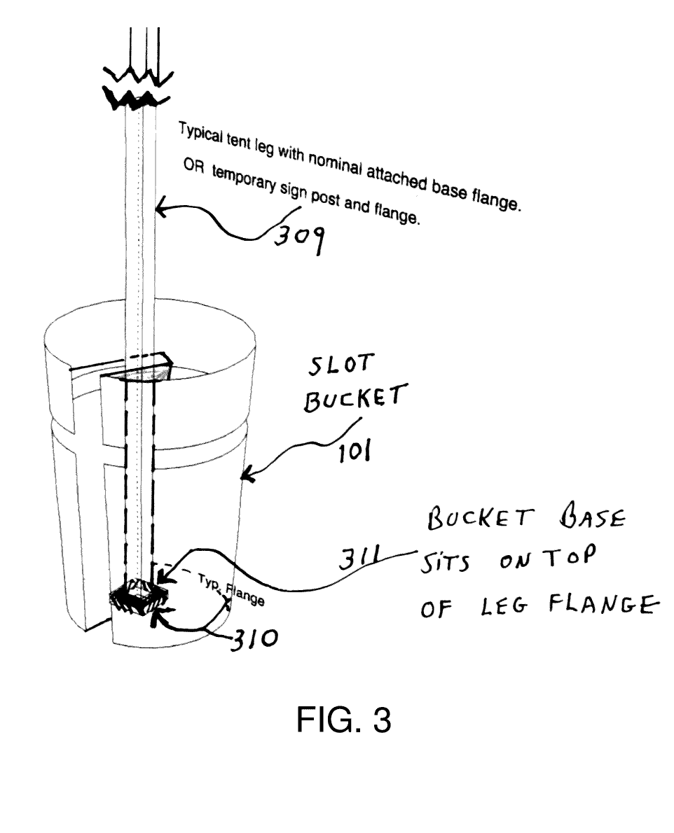

Accordingly, the device 101 can be manufactured as a bucket, barrel, a container, and the like (e.g., cylindrical shaped, rectangular shaped, etc.), and with a slot, indent, and the like, 102 of predetermined shape (e.g., triangular, rounded, rectangular, etc.), width, and length, integrated through a full height of the device 101 configured a vessel that can hold, water, sand, and the like, to add mass to the device 101. As shown in FIG. 1, the indented slot 102 can be configured to extend to a central radius point 104 in the device 101 plus of a distance of about half a predetermined indent width 103 so as to center a structural element 309 shown in FIG. 3 (e.g., a leg of an open tent, shade structure, signs, etc.) in the slot 102. Advantageously, such design, as described, allows the structural element 309, sized just under the width of 103, and of any suitable shape, to be positioned and inserted along the slot 103 and up to the center radius point 104.

In addition, when the device 101 is in position, the mass of the device and its contents (e.g., water, sand, etc.) can be equally distributed around the circumference of the structural element 309. Accordingly, the device 101 can accept liquid, solid, and the like, materials that can also be granular or cast in place as a solid (e.g., cement) for permanent mass addition. The device 101 functions as a container, and as such can effectively hold smaller groupings of weighted objects, and the like, in a confined space to increase mass (e.g., adding 8 five pound bags of sand produces a total device 101 weight when the device 101 is around the size of a 5 gallon bucket, thus exceeding 40 pounds, adding 5 sealed bags of water can produce a weight exceeding 40 pounds of mass, etc.).

FIG. 2 illustrates an integral lid 205 for the device 101 of FIG. 1. In FIG. 2, the lid 205 can be manufactured (e.g., made of plastic using plastic injection molding or 3D printing techniques) with an indented slot 207 that mirrors the slot 102 of the device 101 of FIG. 1. The lid 205 can be centered over the device 101 via an extension of a lip 208 adapted to fit the outside circumference of the device 101. Advantageously, the lid 205 can be revolved to any suitable point thus closing off the top opening of the indented slot 102 of the device 101, to lock in, to some degree, the structural element 309, and so as to also provide resistance to lateral movement to so some degree. The top of the lid 205 has a manufactured lid top indentation 206 that accepts the bottom circumference of the device 101, providing nesting, stackability, and the like.

FIG. 3 illustrates a location of a structural element secured by the device of FIG. 1. In FIG. 3, the structural element 309 (e.g., a leg of an open tent, shade structure, signs, etc.) can be placed within the indented slot 102 of the device 101 at the center of radius point 104. The structural element 309 can typically include an attached flange 310. The indented slot 102 is configured to be smaller than the flange 310 so that the flange 310 cannot to pass through the indented slot 102. The mass of the device 101 and contents thereof are therefore equally distributed at 311 on the flange 310 for advantageously securing the structural element 309 by gravitational force and which that does not employ a fixed mechanical connection between the device 101 and the structural element 309, and achieved by positioning of the device 101 without a need for critical measurements, and the like. The use of the device 101 in the described manner, advantageously, negates a need for additional securing devices, such as straps, ropes, and the like, that can fail at any time and for varied reasons, such as broken connections, and the like.

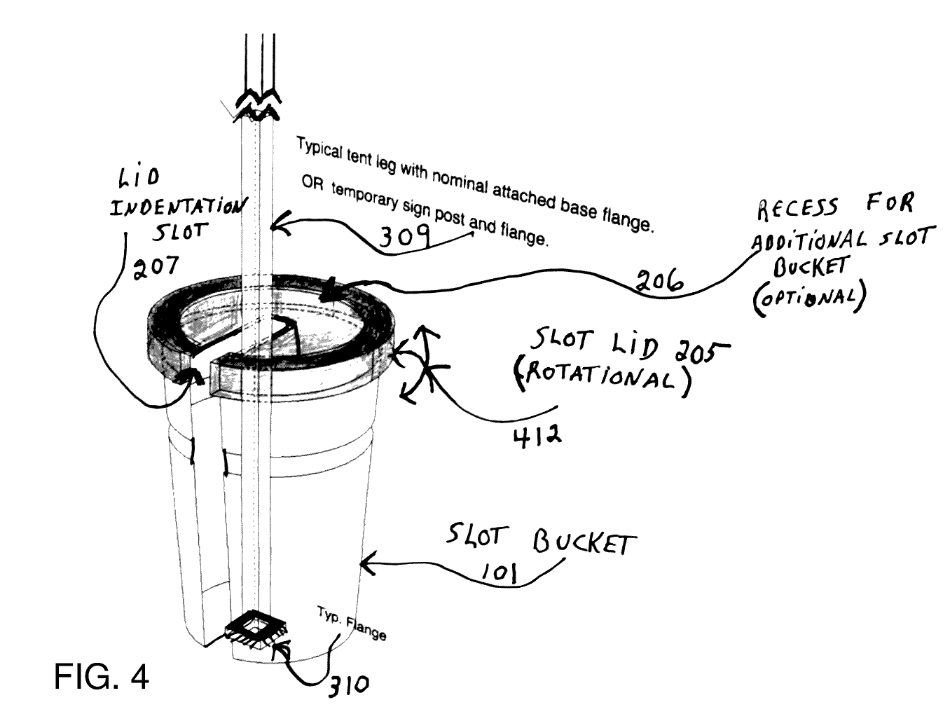

FIG. 4 illustrates the device and lid of FIGS. 1-2 configured around a structural element for securing the structural element. In FIG. 4, the lid top indentation 206, the lid indentation slot 207, and the device 101 are configured around and to secure the structural element 309, and with the bottom of the device 101 over the flange 310 of the structural element 309.

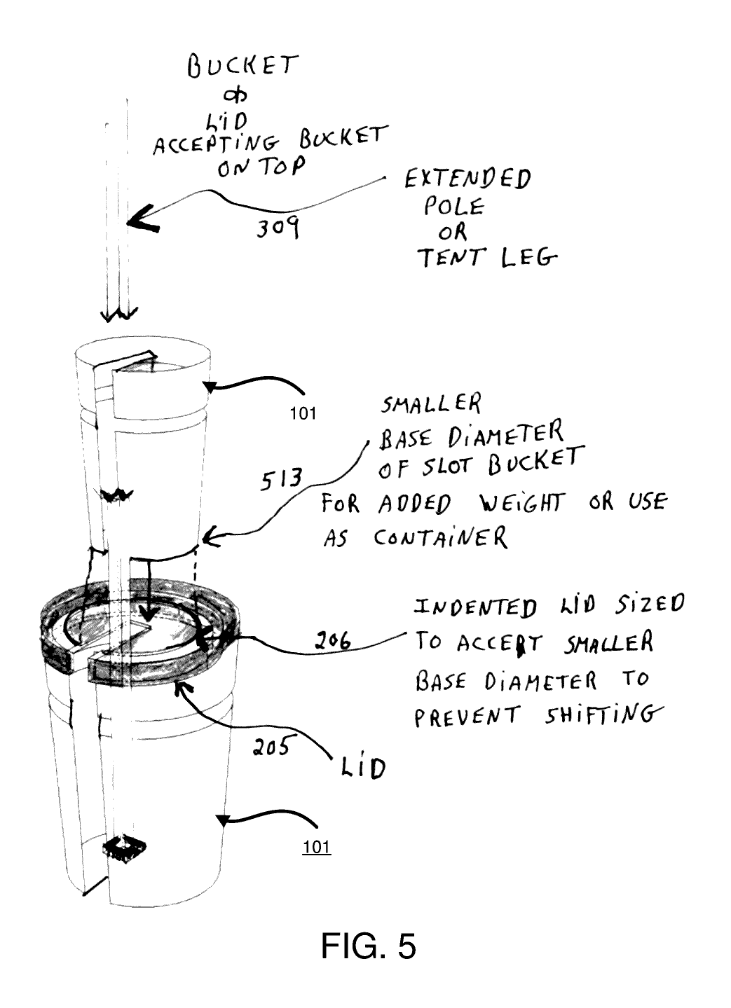

FIG. 5 illustrates a stackability of a device of FIG. 1 over a lid of FIG. 2 of another device of FIG. 1. In FIG. 5, the lid 205 with indent 206 is configured to accept a base 513 of the bottom another the device 101, advantageously, proving the stacking of a device 101 on a lid 205. This advantage allows for additional mass to be added to structural elements if desired. With such a stacking structure, the additional stacked and filled devices 101 add additional mass for holding down and securing structural elements 309

Although the present inventions are described in terms of employing bucket (e.g., 3 or 5 gallon buckets, etc.), barrels (e.g., 55 gallon barrels, etc.), and the like, based on the teachings of the present invention, the devices of the present invention can be adapted in size, shape, and the like, for securing any type of suitable structure having legs to be secured, and the like, as will be appreciated by those of ordinary skill in the relevant art(s).

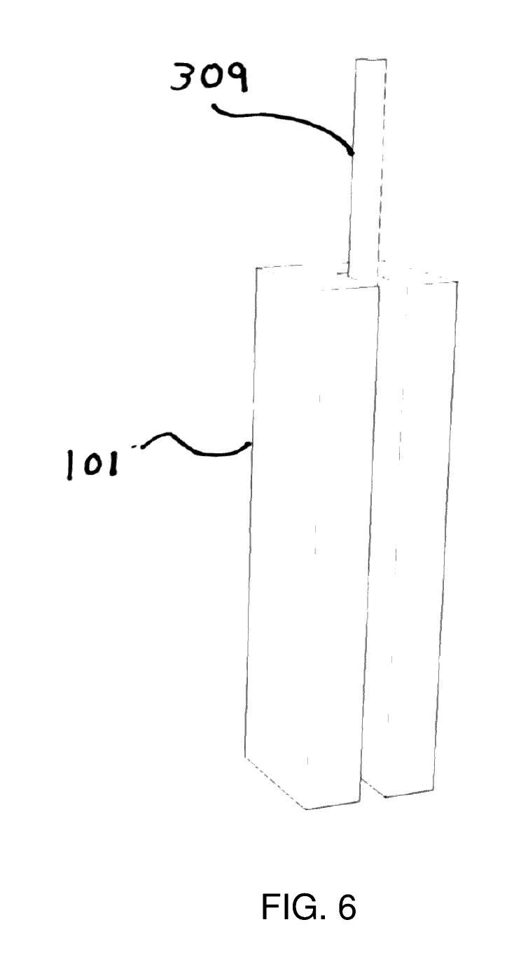

For example, FIG. 6 illustrates a further embodiment of the device described with respect to FIGS. 1-5. In FIG. 6, the device 101 is shown as rectangular shaped instead of round, and the structural element 309 can also be of any suitable; shape, such as round, rectangular shape, and the like, as needed. For example, additional embodiments of the device 101 can be configured to simulate roman columns, keystone block pillars, caricatures, symbols, and the like, wherein the device 101 is configured as a vessel with an indented slot allowing the device 101 to be placed equally around any suitable structural elements 309, and the like.

Accordingly, the teaching of the present invention can include suitable applications with respect to shape, size, contours, artistic expressions of design, suitable materials, and the like, that create a vessel with a slot indentation to the center point of the vessel along a structural object to secure the structural object therein.

Although the present inventions are described in terms of being employed for securing the legs of temporary structures, such as open tents, shade structures, signs, and the like, the teachings of the present invention can be adapted in size, shape, and the like, for securing any type of suitable structure having legs to be secured, and the like, as will be appreciated by those of ordinary skill in the relevant art(s).

While the present inventions have been described in connection with a number of illustrative embodiments, and implementations, the present inventions are not so limited, but rather cover various modifications, and equivalent arrangements, which fall within the purview of the appended claims.

What is claimed is:

1. A device for securing a structural object, the device comprising:
a container having an open top portion and a closed bottom portion; and
a slot integrated into the container through an entire height of the container and to about a central portion of the top and bottom portions, and having a width greater than a width of a pole shaped structural object adapted to be received within the slot.

2. The device of claim 1, wherein the container is cylindrical or rectangular shaped.

3. The device of claim 1, wherein the slot is rectangular, circular or wedge shaped.

4. The device of claim 1, further comprising:
a lid having a slot corresponding to the slot of the container so as to fit over and cover the top portion of the container and rotate therearound.

5. The device of claim 4, wherein the lid includes an indentation adapted to allow stacking of the closed bottom portion of the container on top of the lid.

6. The device of claim 1, wherein the structural object includes a leg of a shade structure, tent or sign.

7. A method for securing a structural object, the method comprising:
providing a container having an open top portion and a closed bottom portion; and
integrating a slot into the container through an entire height of the container and to about a central portion of the top and bottom portions, and having a width greater than a width of a pole shaped structural object adapted to be received within the slot.

8. The method of claim 7, wherein the container is cylindrical or rectangular shaped.

9. The method of claim 7, wherein the slot is rectangular, circular or wedge shaped.

10. The method of claim 7, further comprising:
a lid having a slot corresponding to the slot of the container so as to fit over and cover the top portion of the container and rotate therearound.

11. The method of claim 10, wherein the lid includes an indentation adapted to allow stacking of the closed bottom portion of the container on top of the lid.

12. The method of claim 7, wherein the structural object includes a leg of a shade structure, tent or sign.
